(19) United States
(12) Patent Application Publication
(10) Pub. No.: US 2009/0144278 A1
(43) Pub. Date: Jun. 4, 2009

(54) METHOD AND SYSTEM FOR IMPROVING SOFTWARE QUALITY, USABILITY AND SUPPORT THROUGH AUTOMATED USAGE PATTERN DETECTION

(76) Inventors: ADAM M. GUNTHER, Raleigh, NC (US); Hugh E. Hockett, Raleigh, NC (US); Eric F. Kirchstein, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/949,552

(22) Filed: Dec. 3, 2007

(51) Int. Cl. G06F 17/30

(52) U.S. Cl. 707/6; 707/E17.014

(57) ABSTRACT

A method, system and computer-readable medium for automatically determining common usage patterns of a data processing system and dynamically displaying the information back to a user are disclosed. The method includes automatically recording one or more usage patterns of a data processing system; storing the usage patterns in a repository; identifying one or more common usage patterns among the stored usage patterns; detecting a current usage pattern of a user; comparing the current usage pattern to the common usage patterns; selecting one or more of the common usage patterns that are similar to the current usage pattern; and displaying to the user an indication of one or more common usage patterns similar to the current usage pattern.

### BACKGROUND OF THE INVENTION

The present invention relates in general to the field of computers and computer systems, and in particular to automated detection of computer usage patterns.

The use of computers has become widespread in today's society. The number of computer applications continues to grow, enabling an increasing variety of tasks that can be performed and services that can be provided with a computer. The increase in functionality often has associated with it an increase in complexity. Computers user need a quick and reliable source for answers to questions they encounter while using a computer.

For example, as use of the Internet grows, content and services provided over the Internet continue to expand. The Internet enables businesses to provide customers with access to an increasing variety of “e-commerce” services with the convenience of a personal computer. Today such services include banking services, account management services, customer support services, virtual storefronts for online shopping, instantaneous stock trading, etc. While the expansion of online content and services enables more tasks to be completed over the Internet, this increase in utility also brings an increase in complexity. The average Internet user can find web sites hard to navigate and more sophisticated tasks difficult to complete. For example, a user may be attempting to purchase items from an online store. The checkout process comprises several steps and the user runs into a common error during one of those steps. The user will typically either have to start over and try again, try to find a solution on a customer support site or contact a customer support agent. However, a number of previous users may have encountered the same error and found a solution, yet this information is not readily available to the user.

Similarly, as computer applications evolve, developers typically provide end users with a more robust feature set. While the expansion of application features enables more tasks to be completed using the application, this increase in utility also brings an increase in complexity. The average computer user can find application menus difficult to navigate and more sophisticated tasks difficult to complete. Typically, the user will have to rely on printed manuals, online support documents or technical support agents to find out how to accomplish certain tasks. These options can be time-consuming (e.g., waiting in call queues, searching for relevant information online) and often do not yield the anticipated results, causing frustration. Printed materials quickly become out-of-date, and do not reflect solutions to common problems that users encounter because the printed materials are released at the same time the software is released. Many people prefer not to read software documentation before using an application, and would rather just start using the application. These users would benefit from knowing solutions to common issues and in a way that is readily available to them.

### BRIEF SUMMARY OF THE INVENTION

The present invention provides a method, system and computer program product for automatically determining common usage patterns of a data processing system and dynamically displaying the information back to a user. In one embodiment, the method includes automatically recording one or more usage patterns of a data processing system; storing the usage patterns in a repository; identifying one or more common usage patterns among the stored usage patterns; detecting a current usage pattern of a user; comparing the current usage pattern to the common usage patterns; selecting one or more of the common usage patterns that are similar to the current usage pattern; and displaying to the user an indication of one or more common usage patterns similar to the current usage pattern.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary data processing system in which the present invention may be implemented;

FIG. 2 is a flowchart depicting an exemplary method in accordance with one embodiment of the present invention.

### DETAILED DESCRIPTION OF THE INVENTION

An illustrative embodiment of the present invention is directed to a method, system and computer program product for automatically determining common usage patterns of a data processing system and dynamically displaying the information back to a user. The present invention can take the form of an entirely hardware embodiment, an entirely software embodiment or an embodiment containing both hardware and software elements. In an illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk-read only memory (CD-ROM), compact disk-read/write (CD-R/W) and Digital Versatile Disk (DVD).

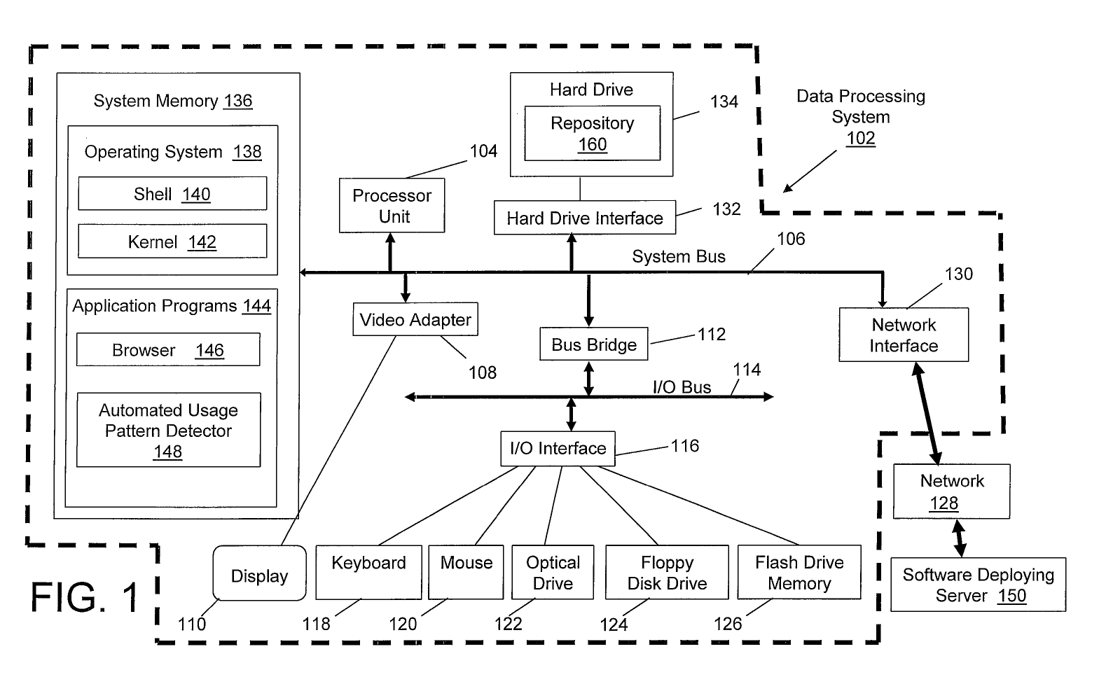

Referring now to the drawings, wherein like numbers denote like parts throughout the several views, FIG. 1 shows a block diagram of a data processing system suitable for storing and/or executing program code in accordance with one or more embodiments of the present invention. The hardware elements depicted in data processing system 102 are not intended to be exhaustive, but rather are representative of one embodiment of the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

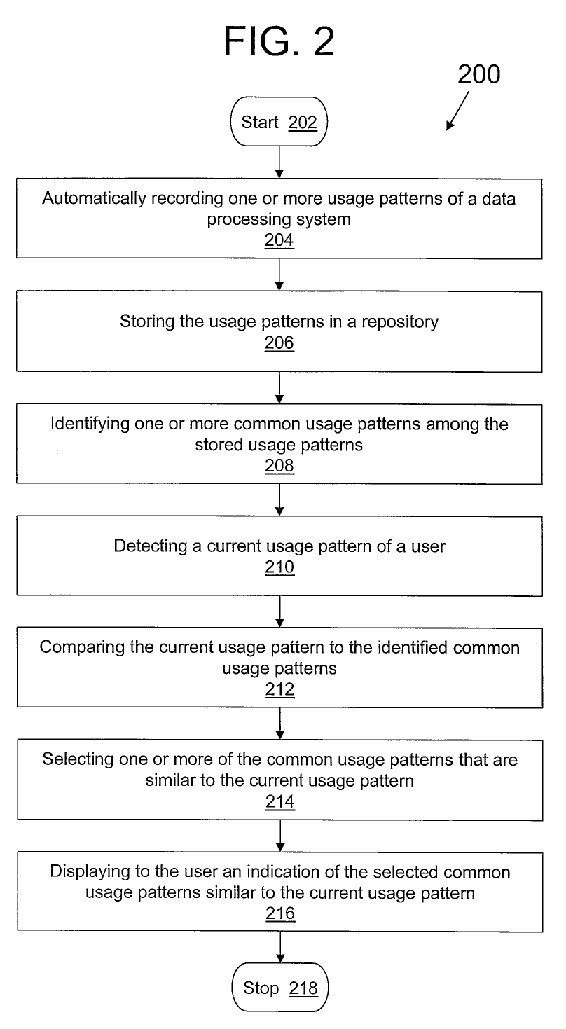

A hard drive interface 132 is also coupled to system bus 106. Hard drive interface 132 interfaces with hard drive 134. In an illustrative embodiment, hard drive 134 populates a system memory 136, which is also coupled to system bus 106. Data that populates system memory 136 includes an operating system (OS) 138 of data processing system 102 and application programs 144. Repository 160 includes one or more storage locations in hard drive 134 that are used to store usage patterns recorded in accordance with one embodiment of the present invention, and discussed in further detail below with reference to FIG. 2.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., data processing system 102) to send and receive network messages to the Internet using HyperText Transfer Protocol (HTTP) messaging, thus enabling communication with software deploying server 150.

Application programs 144 in the system memory of data processing system 102 (as well as the system memory of software deploying server 150) also include a dependency resolver 148. Automated usage pattern detector 148 comprises computer-executable code, at least a portion of which implements the method described herein with reference to FIG. 3. Automated usage pattern detector 148 is described in further detail with reference to FIG. 2. Automated usage pattern detector 148 may reside in system memory 136, as shown, and/or may be stored in non-volatile bulk storage such as hard drive 134. In one embodiment, data processing system 102 is able to download automated usage pattern detector 148 from software deploying server 150.

The hardware elements depicted in data processing system 102 are not intended to be exhaustive, but rather are representative to highlight essential components required by the present invention. For instance, data processing system 102 may include alternate memory storage devices such as magnetic cassettes, Digital Versatile Disks (DVDs), Bernoulli cartridges, and the like. These and other variations are intended to be within the spirit and scope of the present invention.

Note further that, in one embodiment of the present invention, software deploying server 150 performs all of the functions associated with the present invention (including execution of automated usage pattern detector 148), thus freeing data processing system 102 from having to use its own internal computing resources to execute automated usage pattern detector 148.

With reference now to FIG. 2, a flowchart 200 is shown depicting an exemplary method in accordance with one embodiment of the present invention. The method begins at initiator block 202. Automated usage pattern detector 148 automatically records one or more usage patterns of a data processing system 102 (step 204). Usage patterns are recorded as a path from a starting point (e.g., first click in a top menu of an application program 144) until a result occurs (e.g., either a success or failure). The recorded usage patterns are stored in a known format and sent to repository 160 (step 206). While FIG. 1 shows repository 160 as stored in hard drive 134 for purposes of illustration, repository 160 can be stored in any suitable medium for storing data, including system memory 136 or removable media. Repository 160 may reside on a remote data processing system, such as software deploying server 150, which is connected to data processing system 102 by network 128. Any format for storing the usage patterns is acceptable as long as is can be processed by a data processing system. The usage patterns may be stored in a backend database for persistence if deemed necessary.

Automated usage pattern detector 148 aggregates the data in repository 160 and identifies one or more common usage patterns among the stored usage patterns (step 208). Two types of usage patterns are identified. One type is a common path to an end point. For example, the path required to print a document from a word processing program is a path to an end point. The end point is the successful printing of the document. Automated usage pattern detector 148 identifies the most common usage pattern to reach the end point (e.g., click on the file menu, select the print command, select Printer 4, click OK). The other type of usage pattern is a common path to an error. In the printing example above, the error is an unsuccessful attempt to print a document. Automated usage pattern detector 148 identifies the most common path to an error is omitting the step of selecting Printer 4 before clicking OK.

Automated usage pattern detector 148 detects a current usage pattern of a user (step 210) and compares the current usage pattern to the identified common usage patterns (step 212). Automated usage pattern detector 148 selects one or more of the common usage pattern that are similar to the current usage pattern (step 214) and displays to the user an indication of the selected common usage patterns similar to the current usage pattern (step 216). Step 216 can be performed automatically or in response to the occurrence of a predetermined event. The method ends at terminator block 218.

In one embodiment, the occurrence of an error is the predetermined event that initiates step 216. For example, a user is attempting to make an online purchase using a web form. Automated usage pattern detector 148 has identified that the most common path to checkout on the host system comprises step A, then step B, then step C, then step D. Step A creates the order. Step D is the final checkout process. Step B and step C are intermediate steps. If the user experiences an error during step C, automated usage pattern detector 148 suggests to the user common ways to get from step C to step D and points out the positive steps that past users took to overcome the error. For example, automated usage pattern detector 148 displays to the user an indication that 65% of the users who encountered the error did X to get to step D, 26% did Y and 4% did Z. The user is assisted immediately and outside support is not needed to resolve the error.

In an alternative embodiment, a user request for assistance is the predetermined event that initiates step 216. For example, prior to attempting to make an online purchase using a web form, the user requests assistance in completing the transaction by enabling a guide feature on the website. In response, automated usage pattern detector 148 displays an indication of the most common paths to checkout. The indication can comprise real-time guiding that highlights the path as the user goes. The common next clicks can be highlighted to the user to help guide the user. The user learns the proper steps before attempting to complete those steps. The indication can show the user the next popular step or the most common path the reach endpoint X. Alternatively, the indication can allow the user to select between an indication of the next popular step or the most common path the reach endpoint X. This approach helps to alleviate the problem of poorly designed interfaces where some menus are difficult to find. This approach can be more accurate than software documentation because it presents actual usage data.

Automated usage pattern detector 148 can be used with internet applications (e.g., browser application 146) to assist a user in navigating for content. Automated usage pattern detector 148 can be used with desktop applications (e.g., word processing application) to assist a user in navigating for function. Automated usage pattern detector 148 can also be used to provide a user with a patch-on-demand feature for application programs 144. For example, an application program developer can map common error paths identified by automated usage pattern detector 148 to user-installable software updates (“patches”). When the user encounters an identified error, automated usage pattern detector 148 displays an indication that provides information about installing a patch to fix the identified error. For example, the user encounters an error with version 1.0 of an application program when entering the zip code 08765. Automated usage pattern detector 148 recognizes that the most common path to resolving this error is installing a patch to update the application program to version 1.0.2. This information can be immediately displayed to the user and the patch can be supplied automatically.

While the present invention has been particularly shown and described with reference to an illustrative embodiment, it will be understood by those skilled in the art that various changes in form and detail may be made therein without departing from the spirit and scope of the invention. For example, while automated usage pattern detector 148 is shown in FIG. 1 as an application program 144 for purposes of illustration, it would be understood by those skilled in the art that automated usage pattern detector 148 can be included as a feature within an application program 144. Alternatively, automated usage pattern detector 148 can take the form of a client-server system, where usage patterns are recorded on one data processing system and transmitted over network 128 to another data processing system. Software development companies can aggregate this data and improve the documentation, support, etc. provided to end users.

Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

Flowcharts and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A method in a data processing system comprising:
automatically recording one or more usage patterns of a data processing system;
storing said one or more usage patterns in a repository;
identifying one or more common usage patterns among the stored usage patterns;
detecting a current usage pattern of a user;
comparing the current usage pattern to said common usage patterns;
selecting one or more of said common usage patterns that are similar to the current usage pattern; and
displaying to the user an indication of one or more common usage patterns similar to the current usage pattern.

2. The method of claim 1, wherein said identifying further comprises determining one or more common paths to an end point.

3. The method of claim 1, wherein said identifying further comprises determining one or more common paths to errors.

4. The method of claim 1, wherein said displaying occurs in response to a predetermined event.

5. The method of claim 4, wherein said predetermined event is a request by a user.

6. The method of claim 4, wherein said predetermined event is an error occurring while navigating a web site with a browser application.

7. The method of claim 4, wherein said predetermined event is an error occurring during the execution of a computer application program.

8. A system comprising:
means for automatically recording one or more usage patterns of a data processing system;
means for storing said one or more usage patterns in a repository;
means for identifying one or more common usage patterns among the stored usage patterns;
means for detecting a current usage pattern of a user;
means for comparing the current usage pattern to said common usage patterns;
means for selecting one or more of said common usage patterns that are similar to the current usage pattern; and
means for displaying to the user an indication of one or more common usage patterns similar to the current usage pattern.

9. The system of claim 8, wherein said means for identifying farther comprises means for determining one or more common paths to an end point.

10. The system of claim 8, wherein said means for identifying further comprises means for determining one or more common paths to errors.

11. The system of claim 8, wherein said means for displaying is responsive to a predetermined event.

12. The system of claim 11, wherein said predetermined event is a request by a user.

13. The system of claim 11, wherein said predetermined event is an error occurring while navigating a web site with a browser application.

14. The system of claim 11, wherein said predetermined event is an error occurring during the execution of a computer application program.

15. A computer-readable medium encoded with a computer program that, when executed, performs the steps of:
automatically recording one or more usage patterns of a data processing system;
storing said one or more usage patterns in a repository;
identifying one or more common usage patterns among the stored usage patterns;
detecting a current usage pattern of a user;
comparing the current usage pattern to said common usage patterns;
selecting one or more of said common usage patterns that are similar to the current usage pattern; and
displaying to the user an indication of one or more common usage patterns similar to the current usage pattern.

16. The computer-readable medium of claim 15, wherein said identifying further comprises determining one or more common paths to an end point.

17. The computer-readable medium of claim 15, wherein said identifying further comprises determining one or more common paths to errors.

18. The computer-readable medium of claim 15, wherein said displaying occurs in response to a predetermined event.

19. The computer-readable medium of claim 18, wherein said predetermined event is a request by a user.

20. The computer-readable medium of claim 18, wherein said predetermined event is the occurrence of an error.
